(19) United States
(12) Patent Application Publication
(10) Pub. No.: US 2026/0177134 A1
(43) Pub. Date: Jun. 25, 2026

(54) ADVANCED FAULT ATTACK DETECTING DEVICE USING FAULT STATE PROPAGATION

(71) Applicant: SAMSUNG ELECTRONICS CO., LTD., Suwon-si (KR)

(72) Inventors: Ki Hong KIM, Suwon-si (KR); Dongsoo LEE, Suwon-si (KR)

(73) Assignee: SAMSUNG ELECTRONICS CO., LTD., Suwon-si (KR)

(21) Appl. No.: 19/413,294

(22) Filed: Dec. 9, 2025

(30) Foreign Application Priority Data
Dec. 24, 2024 (KR) 10-2024-0195530

(51) Int. Cl. F16H 9/06; B62M 9/132

(52) U.S. Cl. CPC F16H 9/06; B62M 9/132

(57) ABSTRACT

A fault detection circuit includes a logic circuit, and a compare circuit that detects whether a fault is generated in the logic circuit. The logic circuit includes a logic gate circuit including at least one sub logic gate circuit having a multi-bit signal as an input/output, and a flip-flop circuit electrically connected to the logic gate circuit. The flip-flop circuit includes at least one sub flip-flop circuit that latches and outputs data of a signal which the at least one sub logic gate circuit outputs. The compare circuit compares an output signal of the logic circuit and a fault state signal to generate a comparison result and detects whether the fault is generated in the logic circuit, based on the comparison result.

### CROSS-REFERENCE TO RELATED APPLICATIONS

This application claims priority under 35 U.S.C. § 119 to Korean Patent Application No. 10-2024-0195530 filed on December 24, 2024, in the Korean Intellectual Property Office, the disclosures of which are incorporated by reference herein in their entireties.

### BACKGROUND

Embodiments of the present disclosure described herein relate to a fault detection circuit, and more particularly, relate to a circuit capable of detecting a fault attack.

A fault attack refers to an attack method which is used to extract information by inducing unauthorized or unintended operations in a circuit. The fault attack may be implemented through optical fault injection (or an optical glitch), electromagnetic fault injection, body bias injection, etc.

In particular, in an autonomous driving system, a driving assistance system, or an information security device, it is important to detect the fault attack. The lockstep has been widely used as an existing method of defending the fault attack. The lockstep may detect a fault by comparing two outputs of the same core. However, when a fault state generated in the core is not transmitted up to the output, the lockstep has a limitation that it is impossible to detect the fault state.

Accordingly, there is an increasing demand for a fault detection circuit in which the fault generated inside the core is capable of being wholly transmitted up to the output.

### SUMMARY

Embodiments of the present disclosure provide a fault detection circuit capable of improving the performance of detecting a fault attack through fault state propagation.

According to an embodiment, a fault detection circuit may include a logic circuit, and a compare circuit that detects whether a fault is generated in the logic circuit. The logic circuit may include a logic gate circuit including at least one sub logic gate circuit having a multi-bit signal including a plurality of bits as an input/output, and a flip-flop circuit electrically connected to the logic gate circuit. The flip-flop circuit may include at least one sub flip-flop circuit that latches and outputs data of a signal which the at least one sub logic gate circuit outputs, and the compare circuit may compare an output signal of the logic circuit and a fault state signal to generate a comparison result and may detect whether the fault is generated in the logic circuit, based on the comparison result.

According to an embodiment, a fault detection circuit may include a first logic circuit that receives a lower bit signal of a multi-bit input signal including a plurality of bits and performs a logic operation on the lower bit signal, a second logic circuit that receives an upper bit signal of the multi-bit input signal and performs a logic operation on the upper bit signal, the second logic circuit operating in synchronization with the first logic circuit in a lockstep method to detect whether a fault is generated in the first logic circuit, and a compare circuit that outputs a comparison result obtained by comparing a multi-bit output signal of a plurality of bits, which includes output signals of the first logic circuit and the second logic circuit as a lower bit signal and an upper bit signal, with a fault state and to detect whether a fault is generated in the first logic circuit, based on the comparison result. The first logic circuit may include at least one logic gate circuit including a logic gate, and at least one flip-flop circuit including a flip-flop electrically connected to the at least one logic gate circuit. The flip-flop circuit may include at least one D flip-flop that latches and outputs an output received from the at least one logic gate circuit based on a clock signal, and a clock gating circuit that holds data of an output signal of the at least one D flip-flop when the output signal of the at least one D flip-flop is the fault state signal.

According to an embodiment, a method of detecting a fault in a logic circuit may include defining a signal as a true state, a false state, or a fault state, latching a fault state signal input to at least one sub flip-flop circuit included in the logic circuit when a fault is generated in at least one sub logic gate circuit included in the logic circuit, propagating the fault state signal in the logic circuit, outputting, at the logic circuit, an output signal, and outputting, at a compare circuit, a comparison result obtained by comparing the fault state signal and the output signal and detecting whether a fault is generated based on the comparison result.

### BRIEF DESCRIPTION OF THE FIGURES

The above and other objects and features of the present disclosure will become apparent by describing in detail embodiments thereof with reference to the accompanying drawings.

FIG. 1 is a diagram for describing a fault detection circuit according to an embodiment of the present disclosure.

FIGS. 2A and 2B are diagrams for describing a fault detecting operation of a fault detection circuit according to an embodiment of the present disclosure.

FIGS. 3A and 3B are diagrams for describing implementation of a sub logic gate circuit having a signal of a plurality of bits as an input/output signal.

FIGS. 4A and 4B are diagrams for describing true tables of a sub logic gate circuit according to an embodiment of the present disclosure.

FIG. 5 is a diagram for describing implementation of a sub flip-flop circuit having a signal of a plurality of bits as an input/output signal.

FIG. 6 is a timing diagram for describing how a sub flip-flop circuit of FIG. 5 according to an embodiment continuously propagates a signal defined as a fault state.

FIG. 7 is a diagram for describing a compare circuit.

FIG. 8 is a diagram for describing an operation of a fault detection circuit including a logic gate in which polarities of an input and an output are inverted.

FIG. 9 is a diagram for describing an operation of a fault detection circuit including only logic gates in which polarities of an input and an output are not inverted.

FIG. 10 is a diagram for describing an embodiment of a fault detection circuit including a plurality of logic circuits.

FIG. 11 is a flowchart describing an operation of a fault detection circuit.

FIG. 12 is a diagram for describing an embodiment in which a fault detection circuit according to an embodiment of the present disclosure is applied to a security chip.

### DETAILED DESCRIPTION

Below, embodiments of the present disclosure will be described in detail and clearly to such an extent that an ordinary one in the art easily carries out the present disclosure.

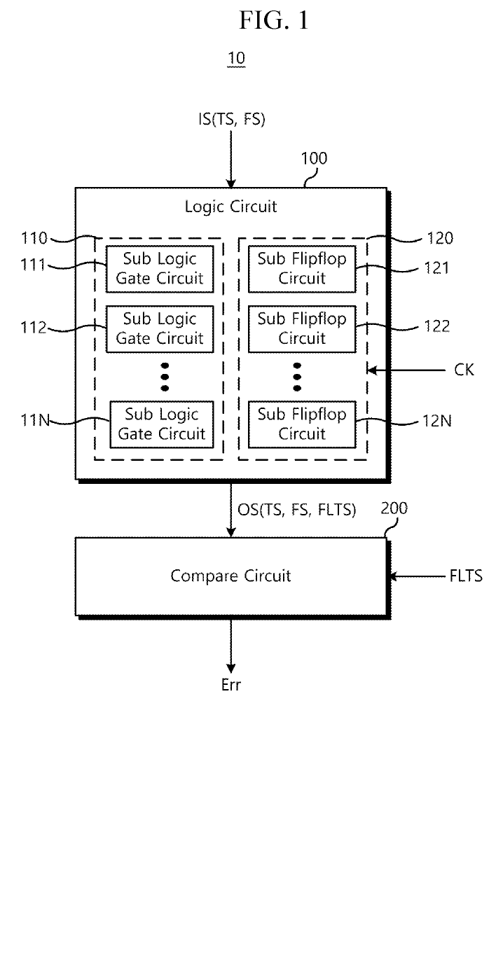

FIG. 1 is a diagram for describing a fault detection circuit 10 according to an embodiment of the present disclosure.

Referring to FIG. 1, the fault detection circuit 10 may detect a fault generated due to the fault attack. For example, the fault detection circuit 10 may be used in a secure memory device, which processes data requiring security, such as a smart card.

In detail, the fault detection circuit 10 may detect a fault by the fault attack so as to be used for the secure memory device such as a smart card to take follow-up measures. However, this is provided as an example, and the fault detection circuit 10 may be used even in an arbitrary secure memory device and/or an arbitrary integrated circuit processing data requiring security.

The fault detection circuit 10 may include a logic circuit 100 and a compare circuit 200.

The logic circuit 100 may perform a logic operation. The logic circuit 100 may perform the logic operation on an input signal IS and may output a final output signal OS to the compare circuit 200.

Each of the input signal IS and the final output signal OS of the logic circuit 100 may be a signal of a plurality of bits (or a multi-bit signal). The input signal IS may be a signal which is defined as a true state TS or a false state FS. The final output signal OS may be a signal which is defined as the true state TS, the false state FS, or a fault state FLTS. The signal defined as the fault state FLTS may be referred to as a “fault state signal”.

For example, when the signal defined as the fault state FLTS is generated in the logic circuit 100 due to the fault attack, the signal defined as the fault state FLTS may be output as the final output signal OS. Accordingly, the logic circuit 100 may refer to a circuit in which there is generated a fault which the fault detection circuit 10 intends to detect.

The logic circuit 100 may include a logic gate circuit 110 and a flip-flop circuit 120.

The logic gate circuit 110 may include a plurality of sub logic gate circuits 111 to 11N. Each of the sub logic gate circuits 111 to 11N may include at least one logic gate. The sub logic gate circuits 111 to 11N are similar in configuration and operation, and thus, below, the sub logic gate circuit 111 will be described as an example.

The sub logic gate circuit 111 may be electrically connected to at least one other sub logic gate circuits 112 to 11N or to the flip-flop circuit 120. The sub logic gate circuit 111 may have a multi-bit signal as an input/output. For example, the sub logic gate circuit 111 may be implemented with a combination of at least one logic gate having a single-bit signal as an input/output.

The flip-flop circuit 120 may include a plurality of sub flip-flop circuits 121 to 12N. Each of the sub flip-flop circuits 121 to 12N may include at least one flip-flop which latches and outputs data of a received signal. For example, each of the sub flip-flop circuits 121 to 12N may include at least one D flip-flop. The sub flip-flop circuits 121 to 12N are similar in configuration and operation, and thus, below, the sub flip-flop circuit 121 will be described as an example.

The sub flip-flop circuit 121 may be electrically connected to the logic gate circuit 110 or the compare circuit 200. The sub flip-flop circuit 121 may have a multi-bit signal as an input/output. For example, the sub flip-flop circuit 121 may be implemented with a combination of at least one flip-flop having a single-bit signal as an input/output.

The sub flip-flop circuit 121 may operate based on a clock signal CK. For example, the sub flip-flop circuit 121 which stores data of a received signal may output the data of the stored signal at the rising edge or the falling edge of the clock signal CK.

The sub flip-flop circuit 121 according to an embodiment of the present disclosure may perform a hold operation in which when the signal defined as the fault state FLTS is output, data of an output signal are continuously held without being changed to data of a new input signal at a next edge of a clock signal.

In other words, when the signal defined as the fault state FLTS is generated, the sub flip-flop circuit 121 may fix the output signal to the signal defined as the fault state FLTS. Accordingly, through the hold operation, the sub flip-flop circuit 121 may prevent the signal from being restored to the signal defined as the true state TS or the signal defined as the false state FS at the next edge of the clock signal.

As a result, when the signal defined as the fault state FLTS is generated, the flip-flop circuit 120 may continuously output the signal defined as the fault state FLTS such that the signal defined as the fault state FLTS is continuously propagated to the logic gate circuit 110 of a next stage or to the remaining sub flip-flop circuits 122 to 12N.

The compare circuit 200 may receive the final output signal OS output from the logic circuit 100 and the signal defined as the fault state FLTS provided from the outside. The compare circuit 200 may compare the final output signal OS and the signal defined as the fault state FLTS and may output an error occurrence signal Err based on a comparison result. The error occurrence signal Err may be a signal which means that the fault detection circuit 10 detects a fault.

For example, the compare circuit 200 may include an XOR gate. In this case, when the logic circuit 100 outputs the signal defined as the fault state FLTS, because the output of the logic circuit 100 is the same as the signal defined as the fault state FLTS, the compare circuit 200 may output the error occurrence signal Err as an output signal of the XOR gate.

As described above, when the fault state FLTS is generated in the logic circuit 100, the sub flip-flop circuit 121 may continuously output the signal defined as the fault state FLTS in advance. Accordingly, when the fault state is generated, the fault detection circuit 10 may continuously propagate the signal defined as the fault state FLTS so as to be output as the final output signal OS. Finally, the compare circuit 200 may compare the final output signal OS and the signal defined as the fault state FLTS and may output the error occurrence signal Err based on a comparison result.

As a result, when the fault state is generated, the fault detection circuit 10 may continuously propagate the signal defined as the fault state FLTS so as to be transferred up to the output, and thus, a fault detection rate may be improved without increasing the burden of hardware.

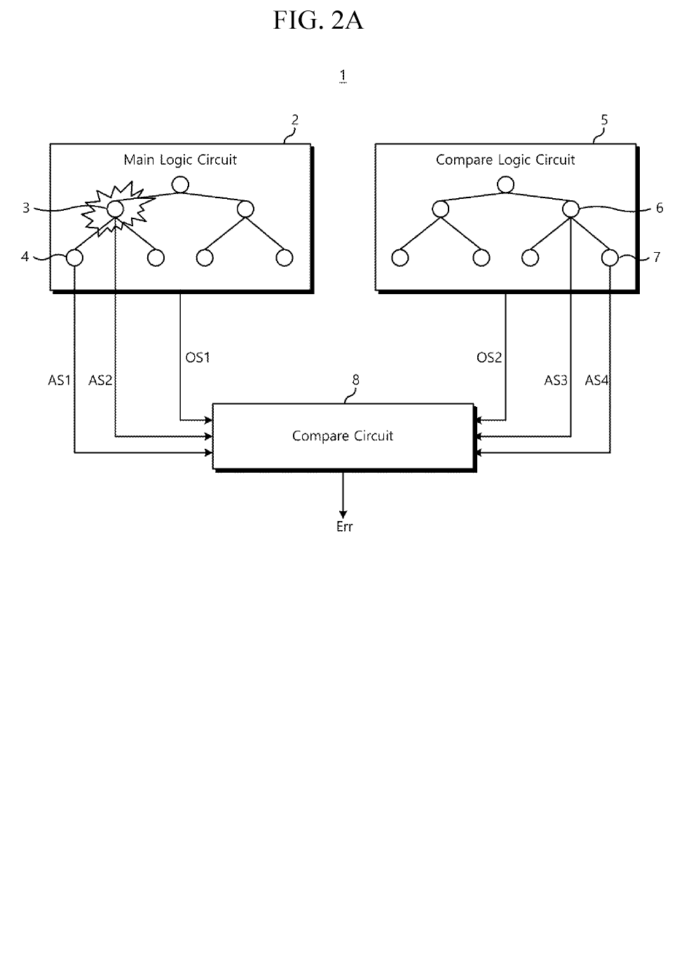

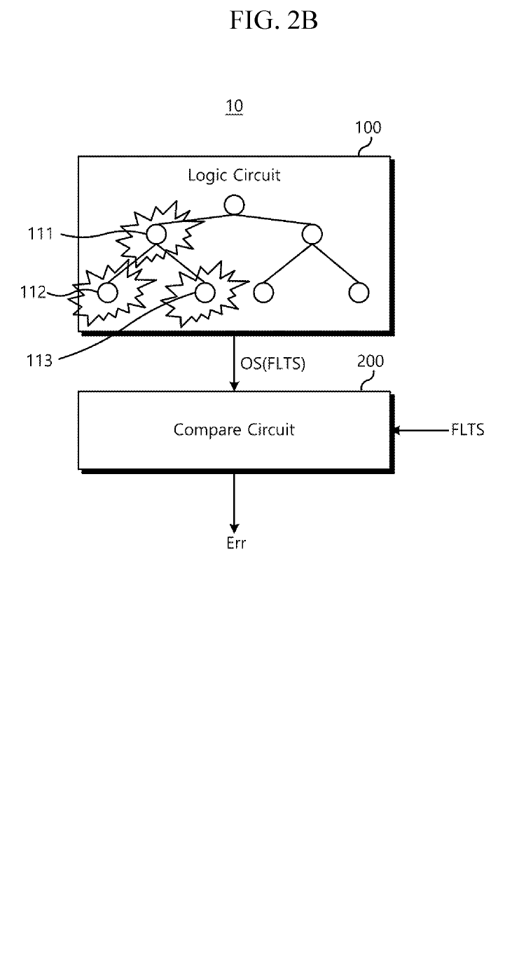

FIGS. 2A and 2B are diagrams for describing a fault detecting operation of the fault detection circuit 10 according to an embodiment of the present disclosure. In an embodiment, a comparative example of performing the fault detecting operation is illustrated in FIG. 2A. An example of the fault detecting operation according to an embodiment of the present disclosure is illustrated in FIG. 2B.

Referring to FIG. 2A, a fault detection circuit 1 according to the comparative example may include a main logic circuit 2, a compare logic circuit 5, and a compare circuit 8.

The main logic circuit 2 may include at least one logic gate and a flip-flop. The main logic circuit 2 may perform the logic operation and may be a target circuit in which there is generated a fault which the fault detection circuit 1 according to the comparative example intends to detect.

The compare logic circuit 5 may perform the same logic operation as the main logic circuit 2 and may operate in a state where the compare logic circuit 5 operates in synchronization with the main logic circuit 2 in a dual core lock step manner to detect whether a fault is generated in the main logic circuit 2.

The compare circuit 8 may compare outputs of the main logic circuit 2 and the compare logic circuit 5 and may output the error occurrence signal Err, which indicates that the fault is detected, based on a comparison result.

FIG. 2A illustrates an example of the case where the fault is generated in a logic gate 3 of the main logic circuit 2. To improve the fault detection rate, a fault detection circuit 1 according to the comparative example additionally requires an internal node for propagating the fault state, which is generated at logic gates in the main logic circuit 2 and the compare logic circuit 5, up to the output. As a result, a signal which the main logic circuit 2 outputs may further include an output signal of each of the logic gates.

For example, referring to FIG. 2A, the fault detection circuit 1 according to the comparative example may further require an internal node for additionally outputting an output signal AS2 of the logic gate 3 and an output signal AS1 of a logic gate 4 to the compare circuit 8 in addition to a final output signal OS1 of the main logic circuit 2. Likewise, the compare logic circuit 5 according to the comparative example may further require an internal node for additionally outputting an output signal AS3 of a logic gate 6 and an output signal AS4 of a logic gate 7 to the compare circuit 8 in addition to a final output signal OS2 of the compare logic circuit 5.

The compare circuit 8 may further include a plurality of comparators for outputting results of comparing the output signals, a comparison result collection circuit, etc.

As a result, to improve the fault detection rate, the fault detection circuit 1 according to the comparative example additionally requires the internal node of the main logic circuit 2, the internal node of the compare logic circuit 5, the plurality of comparators of the compare circuit 8, the comparison result collection circuit of the compare circuit 8, etc. According to the above description, the fault detection circuit 1 according to the comparative example inevitably accompanies the increase in hardware burden to improve the fault detection rate.

Referring to FIG. 2B, the fault detection circuit 10 according to an embodiment of the present disclosure may continuously propagate the signal defined as the fault state FLTS generated in the logic gate circuit 110 so as to be transferred up to the final output signal OS.

For example, as illustrated in FIG. 2B, the signal defined as the fault state FLTS generated in the sub logic gate circuit 111 may be propagated to the sub logic gate circuit 112 and the sub logic gate circuit 113 so as to be output up to the final output signal OS. Accordingly, the fault detection circuit 10 does not require an additional internal node for transferring the output signal of each of the sub logic gate circuits 111, 112, and 113 up to the final output.

Also, the fault detection circuit 10 may compare the final output signal OS only with the signal defined as the fault state FLTS and may output the error occurrence signal Err. Accordingly, the compare circuit 200 may not additionally require a comparator, a comparison result collection circuit, etc.

As described above, when the signal defined as the fault state FLTS is generated, the fault detection circuit 10 may continuously propagate the signal defined as the fault state FLTS inside the fault detection circuit 10 so as to be transferred up to the final output signal OS. Accordingly, compared to the fault detection circuit 1 according to the comparative example, the fault detection rate may be improved without increasing the burden of hardware.

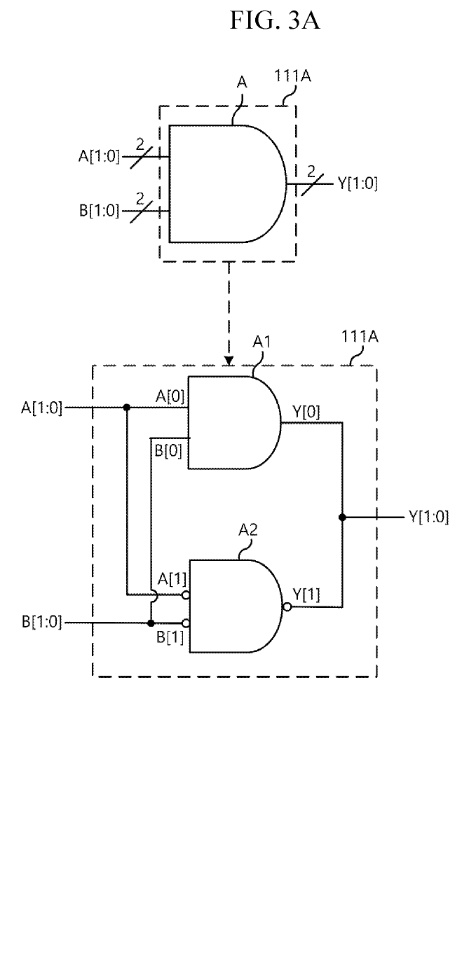

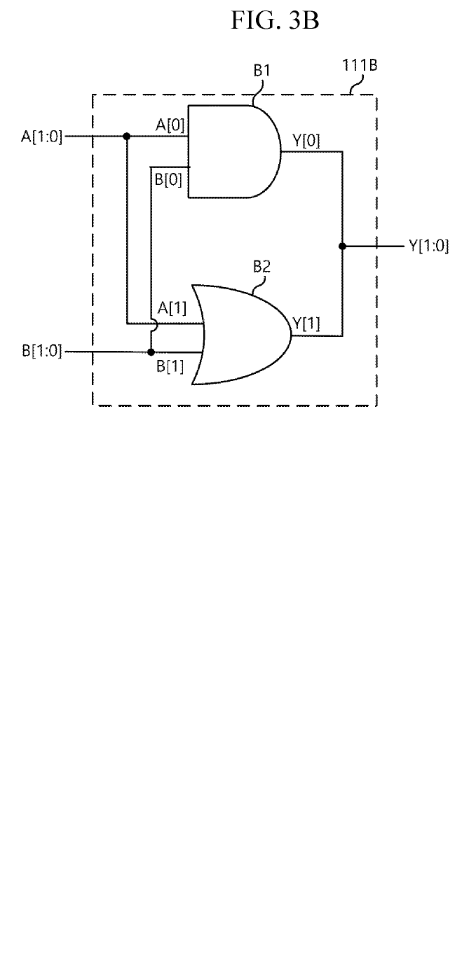

FIGS. 3A and 3B are diagrams for describing implementation of the sub logic gate circuit 111 having a signal of a plurality of bits as an input/output signal. A sub logic gate circuit 111A of FIG. 3A or a sub logic gate circuit 111B of FIG. 3B may correspond to any one of the sub logic gate circuits 111 to 11N of FIG. 1.

Referring to FIG. 3A, the sub logic gate circuit 111A may include at least one logic gate. FIG. 3A shows the case where the sub logic gate circuit 111A includes an AND gate “A” having a signal of a plurality of bits (or a multi-bit signal) as an input/output signal. In this case, the AND gate “A” may be implemented by using AND gates A1 and A2 each having a signal of at least one bit as an input/output signal. However, this is provided as an example, and the sub logic gate circuit 111A may include a logic gate, which performs any other logic operation, such as an OR gate, a NOT gate, a NAND gate, a NOR gate, an XOR gate, or an XNOR gate.

Referring to FIG. 3A, the AND gate “A” may be implemented by using the AND gate A1 in which polarities of an input and an output are not inverted and the AND gate A2 in which polarities of an input and an output are inverted.

When the AND gate “A” includes the AND gate A2 in which polarities of an input and an output are inverted, the fault detection rate may be improved compared to the case where the AND gate “A” includes only the AND gate A1 in which polarities of an input and an output are not inverted. In detail, because the AND gate A1 and the AND gate A2 are different in input/output polarities, when the same fault is generated, influences due to a circuit difference of logic gates may not be identical, and thus, the sub logic gate circuit 111A may be more advantageous to fault detection.

For example, when a fault is generated, the AND gate A1 may not output the signal defined as the fault state FLTS. However, because polarities of an input and an output of the AND gate A2 are inverted, the influence due to the circuit difference with the AND gate A1 may change; in this case, when a fault is generated, the AND gate A2 may output the signal defined as the fault state FLTS. Accordingly, the generation of the fault may appear more clearly by comparing the outputs of the AND gate A1 and the AND gate A2.

Referring to FIG. 3B, the AND gate A2 in which polarities of an input and an output are inverted may be implemented in a simpler structure by replacing the AND gate A2 with an OR gate B2 based on the De Morgan’s Law. In this case, the sub logic gate circuit 111B may be implemented by using an AND gate B1 and the OR gate B2. When a logic gate is implemented through the replacement based on the De Morgan’s Law, a configuration of a circuit may be simpler, and thus, the circuit area and power consumption may be reduced.

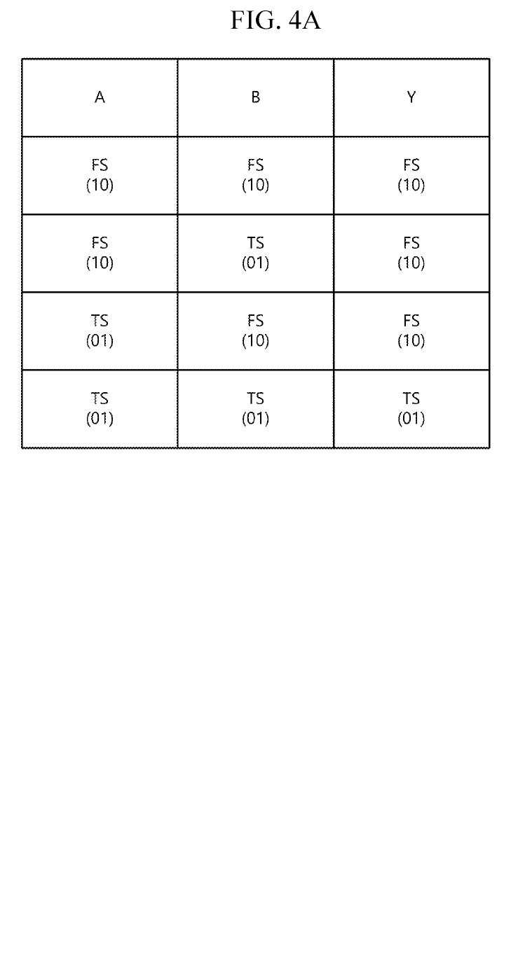

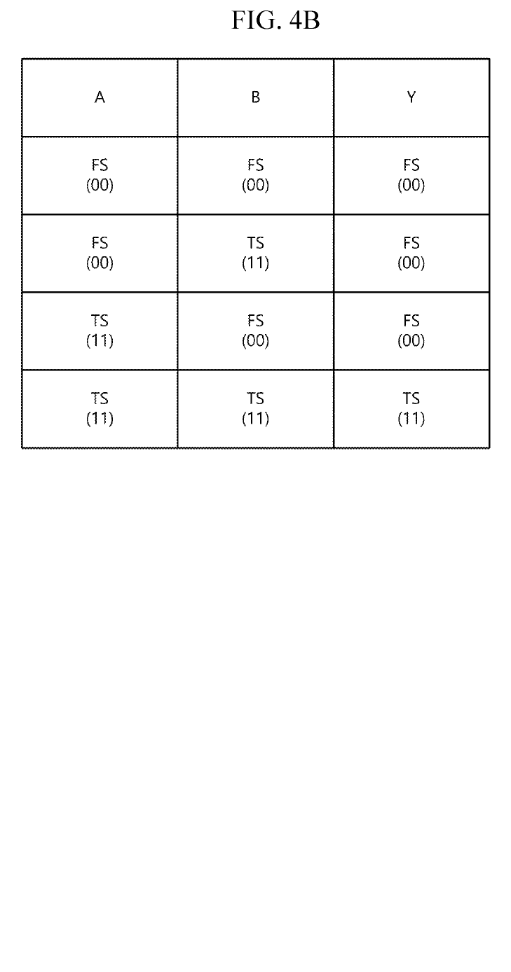

In the case of FIG. 3A, the signals corresponding to the true state TS and the false state FS may be defined, for example, the true state TS may be defined as a signal having data “10”, and the false state FS may be defined as a signal having data “01”. In this case, as the remaining signals except for the signals corresponding to the true state TS and the false state FS, a signal having data “00” and a signal having data “11” may be defined as the fault state FLTS. In this case, the true table of the AND gate “A” is illustrated in FIG. 4A.

In other words, the fault detection circuit 10 may extend an existing single-bit signal to a multi-bit signal. That is, the existing signals corresponding to the true state TS and the false state FS may be mapped to a plurality of bits. Also, a signal except for the signals of the true state TS and the false state FS may be defined as the signal defined as the fault state FLTS.

In this case, because the sub logic gate circuit 111A should have the multi-bit signal as an input/output signal, the sub logic gate circuit 111A may be implemented by using the AND gate A1 and the AND gate A2 each having the single-bit signal as an input/output signal. Also, as the sub logic gate circuit 111A includes the AND gate A2 in which polarities of an input and an output are inverted, the influence due to the circuit difference when a fault is generated may change, and thus, the fault detection rate may be improved.

In this case, when a fault is generated due to the fault attack from the outside, the sub logic gate circuit 111A may output a signal having data “00” or data “11” corresponding to the signal defined as the fault state FLTS as an output signal Y[1:0].

Below, unless otherwise mentioned in the specification, it is assumed that the sub logic gate circuit 111 includes a logic gate in which polarities of an input and an output are inverted. Also, it is assumed that the true state TS corresponds to a signal having data “01”, the false state FS corresponds to a signal having data “10”, and the signal defined as the fault state FLTS corresponds to signals having data “00” and data “11”.

However, the case of FIG. 3A is provided as an example, and the AND gate “A” of the sub logic gate circuit 111A may be implemented by using only logic gates in which polarities of a plurality of inputs and a plurality of outputs are not inverted. In the case, the true state TS may be defined as a signal having data “11”, and the false state FS may be defined as a signal having data “00”. Also, signals having data “10” and data “01” except for data “11” and data “00” may be defined as the signal defined as the fault state FLTS. In this case, the true table of the AND gate “A” is illustrated in FIG. 4B.

In this case, when a fault is generated due to the fault attack from the outside, the sub logic gate circuit 111 may output a signal having data “10” or data “01” corresponding to the signal defined as the fault state FLTS.

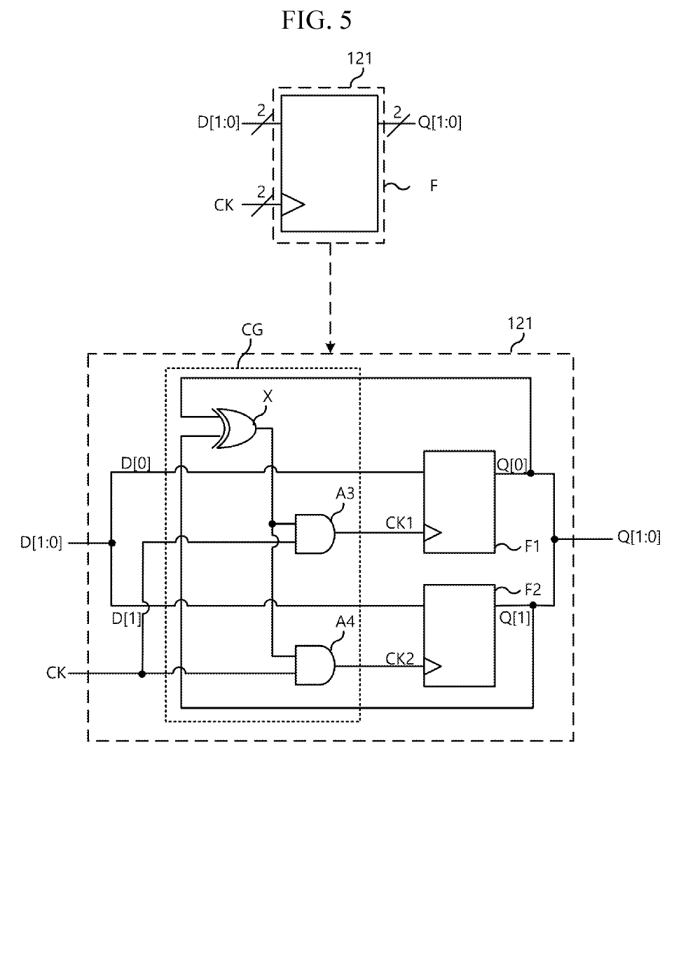

FIG. 5 is a diagram for describing implementation of the sub flip-flop circuit 121 having a signal of a plurality of bits as an input/output signal.

For example, FIG. 5 shows the case where the sub flip-flop circuit 121 includes a D flip-flop “F” having a signal of a plurality of bits (or a multi-bit signal) as an input/output signal. In this case, the D flip-flop “F” may be implemented by using D flip-flops F1 and F2 each having a signal of at least one bit as an input/output signal.

The sub flip-flop circuit 121 may receive a multi-bit signal as an FF input signal D[1:0] and may output an FF output signal Q[1:0] based on the clock signal CK.

For example, the sub flip-flop circuit 121 may output data of the FF input signal D[1:0] as the FF output signal Q[1:0] at the rising edge of the clock signal CK. Also, when the FF output signal Q[1:0] is the signal defined as the fault state FLTS, in other words, when the data of the FF output signal Q[1:0] are data “11” or data “00”, the sub flip-flop circuit 121 may perform the hold operation in which the data of the FF output signal Q[1:0] are continuously held without being changed to data of a new FF input signal D[1:0] at a next rising edge of the clock signal CK.

Referring to FIG. 5, the sub flip-flop circuit 121 may include a first D flip-flop F1, a second D flip-flop F2, and a clock gating circuit CG.

The first D flip-flop F1 may receive a first FF input signal D[0]. The first FF input signal D[0] may be a signal D[0] of a lower bit among a plurality of bits of the FF input signal D[1:0] provided from the logic gate circuit 110. That is, the lower bit signal D[0] may be a signal including data of the lower bit among the plurality of bits of the FF input signal D[0].

The first D flip-flop F1 may generate a first FF output signal Q[0] based on a first clock signal CK1. The first FF output signal Q[0] may be the lower bit signal Q[0] of the FF output signal Q[1:0]. The first D flip-flop F1 may change the data of the first FF output signal Q[0] to the data of the first FF input signal D[0] at the rising edge of the first clock signal CK1 and may output the first FF output signal Q[0] including the changed data.

The second D flip-flop F2 may receive a second FF input signal D[1]. The second FF input signal D[1] may be a signal D[1] of an upper bit among the plurality of bits of the FF input signal D[1:0] provided from the logic gate circuit 110. That is, the upper bit signal D[1] may be a signal including data of the upper bit among the plurality of bits of the FF input signal D[1:0].

The second D flip-flop F2 may generate a second FF output signal Q[1] based on a second clock signal CK2. The second FF output signal Q[1] may be the upper bit signal Q[1] of the FF output signal Q[1:0]. The second D flip-flop F2 may change the data of the second FF output signal Q[1] to the data of the second FF input signal D[1] at the rising edge of the second clock signal CK2 and may output the second FF output signal Q[1] including the changed data.

The first clock signal CK1 and the second clock signal CK2 may be generated based on the first FF output signal Q[0], the second FF output signal Q[1], and the clock signal CK.

As describe above with reference to FIG. 3A, FIG. 5 shows the sub flip-flop circuit 121

when data of the signal defined as the fault state FLTS are “11” and “00”. When the first FF output signal Q[0] is the same as the second FF output signal Q[1], the FF output signal Q[1:0] of the sub flip-flop circuit 121 may be the signal defined as the fault state FLTS.

In other words, because the first FF output signal Q[0] is the lower bit signal of the FF output signal Q[1:0] and the second FF output signal Q[1] is the upper bit signal of the FF output signal Q[1:0], when the first FF output signal Q[0] is the same as the second FF output signal Q[1], the FF output signal Q[1:0] may be a signal having data “11” or “00”. That is, the FF output signal Q[1:0] may be the signal defined as the fault state FLTS.

When the FF output signal Q[1:0] of the sub flip-flop circuit 121 is the signal defined as the fault state FLTS, under control of the clock gating circuit CG, there may be performed the hold operation in which the data of the FF output signal Q[1:0] are not changed to the data of a next FF input signal D[1:0] any more. For example, the clock gating circuit CG may be implemented by an XOR gate “X” and a plurality of AND gates A3 and A4.

The XOR gate “X” may receive the first FF output signal Q[0] and the second FF output signal Q[1]. When the first FF output signal Q[0] is the same as the second FF output signal Q[1], in other words, when the FF output signal Q[1:0] is the signal defined as the fault state FLTS, the XOR gate “X” may output a signal corresponding to data “0”. The output of the XOR gate “X” may be input to the AND gates A3 and A4 together with the clock signal CK.

As described above, the first D flip-flop F1 and the second D flip-flop F2 may change the data of the first FF output signal Q[0] and the data of the second FF output signal Q[1] to the data of the first FF input signal D[0] and the second FF input signal D[1] at the rising edges of the first clock signal CK1 and the second clock signal CK2. Accordingly, when the FF output signal Q[1:0] is the signal defined as the fault state FLTS, the AND gates A3 and A4 may receive a signal of data “0” which the XOR gate “X” outputs and the clock signal CK having data “1” at the rising edge of the clock signal CK.

As a result, when the FF output signal Q[1:0] is the signal defined as the fault state FLTS, the first clock signal CK1 and the second clock signal CK2 which are signals which the AND gates A3 and A4 output may hold a signal having data “0”.

In other words, when the FF output signal Q[1:0] is the signal defined as the fault state FLTS, the rising edges of the first clock signal CK1 and the second clock signal CK2 may not be generated. That is, when the FF output signal Q[1:0] is the signal defined as the fault state FLTS, under control of the clock gating circuit CG, the data of the FF output signal Q[1:0] may not be changed to a next FF input signal D[1:0], and the FF output signal Q[1:0] may be continuously held as the signal defined as the fault state FLTS.

However, this is provided as an example, and when a logic gate of the logic gate circuit 110 is implemented by using a plurality of logic gates in which polarities of an input and an output are not inverted, the clock gating circuit CG may include an XNOR gate instead of an XOR gate.

As described above, when the FF output signal Q[1:0] is the signal defined as the fault state FLTS, the sub flip-flop circuit 121 may hold the data of the FF output signal Q[1:0] as the signal defined as the fault state FLTS without changing the data of the FF output signal Q[1:0]. Accordingly, the fault may be continuously propagated to the logic gate circuit 110 of a next stage and/or the remaining sub flip-flop circuits 122 to 12N.

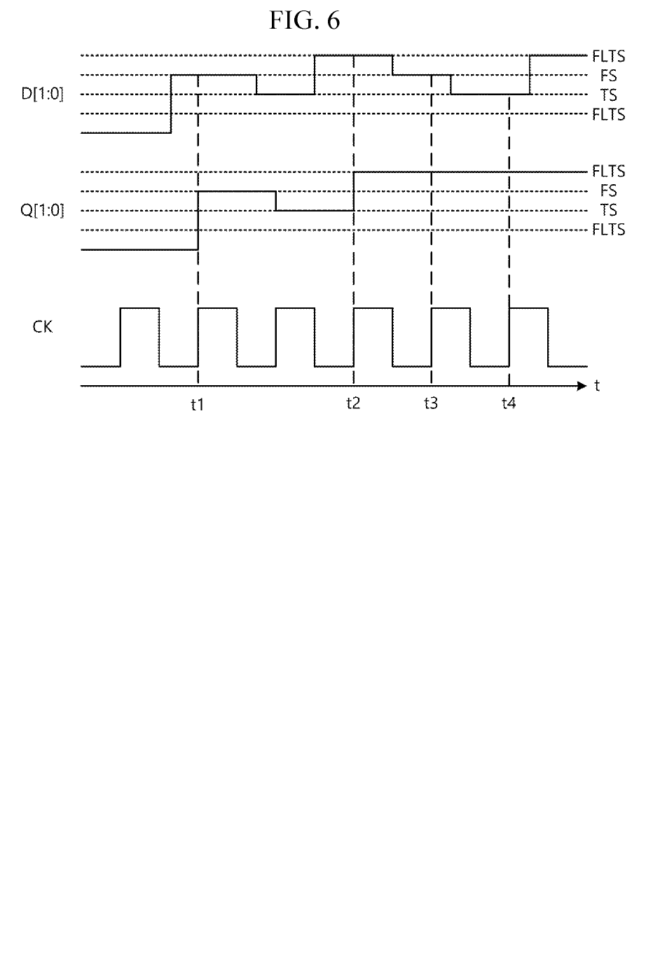

FIG. 6 is a timing diagram for describing how the sub flip-flop circuit 121 of FIG. 5 according to an embodiment continuously propagates the signal defined as the fault state FLTS.

Changes in data levels of the FF input signal D[1:0] and the FF output signal Q[1:0] of the flip-flop circuit 120 based on the clock signal CK will be described with reference to FIG. 6.

As describe above, at the rising edge of the clock signal CK, the sub flip-flop circuit 121 may change the data of the FF output signal Q[1:0] to the data of the FF input signal D[1:0] and may output the FF output signal Q[1:0] including the changed data. For example, at the rising edge of the clock signal CK generated at a time point t1 of FIG. 6, the data of the FF output signal Q[1:0] may be changed and output to the false state (FS) data being the data of the FF input signal D[1:0].

In this case, because the data of the FF output signal Q[1:0] are not the fault state (FLTS) data, the clock gating circuit CG of the sub flip-flop circuit 121 may not hold the FF output signal Q[1:0] as the signal defined as the fault state FLTS.

However, when the data of the FF output signal Q[1:0] are changed and output to the data of the FF input data D[1:0] at the rising edge of the clock signal CK generated at a time point t2 of FIG. 6, because the data of the FF output signal Q[1:0] are the fault state (FLTS) data, the clock gating circuit CG may hold the FF output signal Q[1:0] as the signal defined as the fault state FLTS.

In other words, afterwards, even though the rising edge of the clock signal CK is generated, as illustrated in FIG. 6 from time points t3 and t4, the data of the FF output signal Q[1:0] may be held as the signal defined as the fault state FLTS rather than changed to the data of the FF input signal D[1:0].

As described above, when the FF output signal Q[1:0] is the signal defined as the fault state FLTS, under control of the clock gating circuit CG, the sub flip-flop circuit 121 may hold the FF output signal Q[1:0] such that the signal defined as the fault state FLTS is continuously propagated to a next stage. Accordingly, the fault detection rate of the fault detection circuit 10 may be improved.

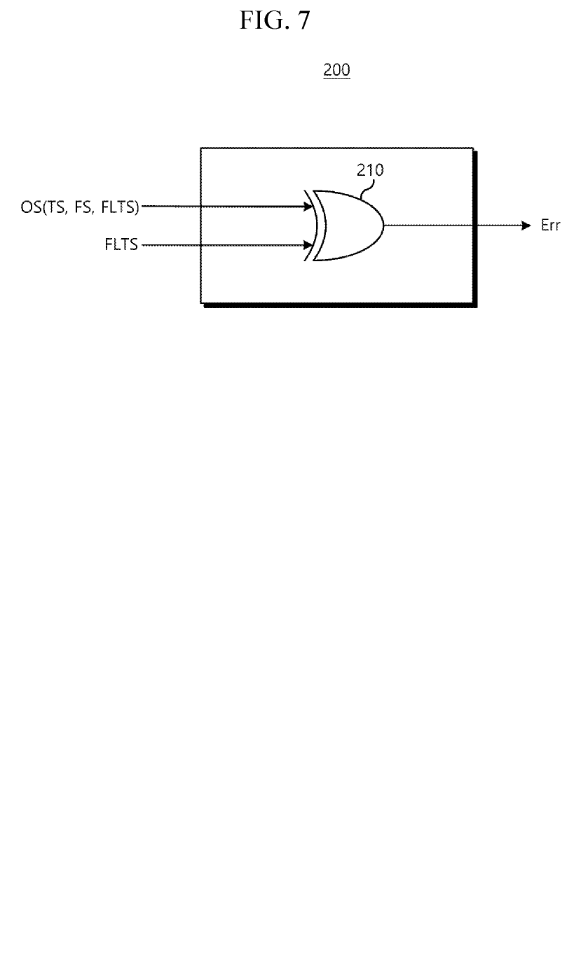

FIG. 7 is a diagram for describing the compare circuit 200.

Referring to FIG. 7, the compare circuit 200 may include an XOR gate 210.

The XOR gate 210 may receive the final output signal OS from the logic circuit 100 and may receive the signal defined as the fault state FLTS provided from the outside. The XOR gate 210 may compare the final output signal OS and the signal defined as the fault state FLTS and may output the error occurrence signal Err based on a comparison result. The final output signal OS may be one of the signal defined as the true state TS, the signal defined as the false state FS, or the signal defined as the fault state FLTS.

For example, the final output signal OS may be a signal having data “11”. In this case, because the final output signal OS is the same as a signal of data “11” being the signal defined as the fault state FLTS, the XOR gate 210 may output a signal having data “0”.

Alternatively, the final output signal OS may be a signal having data “10”. In this case, because the final output signal OS is different from a signal having data “11” and a signal having data “00”, the XOR gate 210 may output a signal having data “1”. The signal of data “1” which the XOR gate 210 outputs may correspond to the error occurrence signal Err.

Unlike the above description, when the logic gate circuit 110 is implemented by using only logic gates in which polarities of a plurality of inputs and a plurality of outputs are not inverted, for example, the final output signal OS may be a signal having data “10”.

In this case, because the final output signal OS is the same as a signal of data “10” being the signal defined as the fault state FLTS, the XOR gate 210 may output a signal having data “0”. Alternatively, the final output signal OS may be a signal having data “11”. In this case, because the final output signal OS is different from a signal having data “10” and a signal having data “01”, the XOR gate 210 may output a signal having data “1”. The signal of data “1” which the XOR gate 210 outputs may correspond to the error occurrence signal Err.

However, this is provided as an example, and when a plurality of final output signals OS are received, the compare circuit 200 may further include an OR gate. In detail, the compare circuit 200 may further include an OR gate to output the error occurrence signal Err when any one of the plurality of final output signals OS is the signal defined as the fault state FLTS. In this case, the compare circuit 200 may include a plurality of XOR gates 210.

For example, the OR gate may receive signals which the plurality of XOR gates output; when at least one of the received signals is a signal having data “1”, the OR gate may output a signal of data “1” corresponding to the error occurrence signal Err.

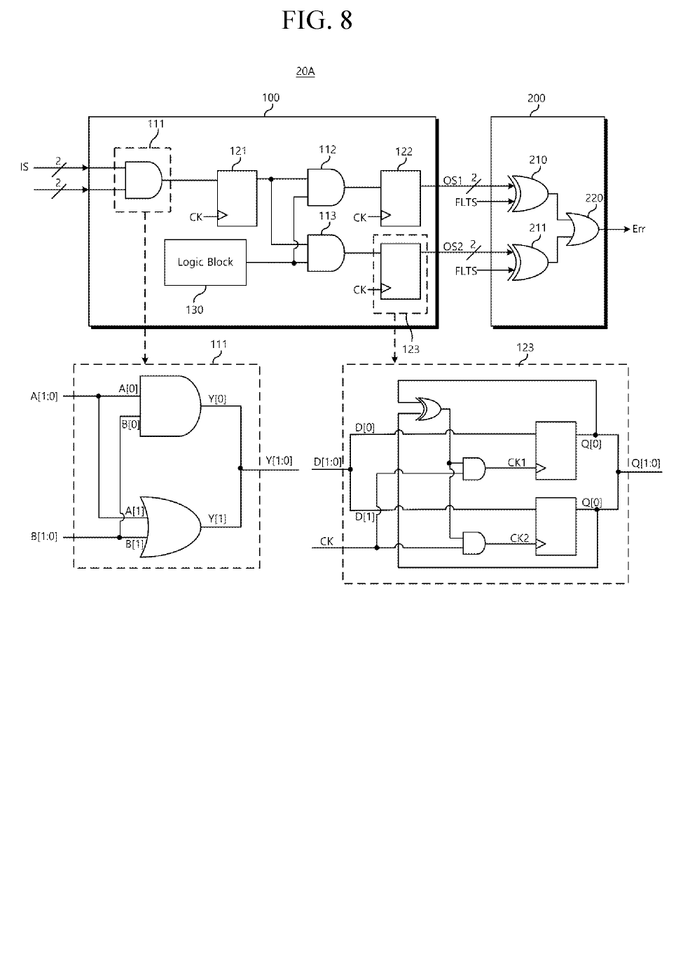

FIG. 8 is a diagram for describing an operation of a fault detection circuit 20A including a logic gate in which polarities of an input and an output are inverted. The fault detection circuit 20A of FIG. 8 is similar to the fault detection circuit described with reference to FIGS. 1 to 7. Accordingly, below, the description which is the same as or similar to the description of the embodiments given with reference to FIGS. 1 to 7 will be omitted to avoid redundancy.

Referring to FIG. 8, for example, the fault detection circuit 20A shows the case in which each of the sub logic gate circuits 111, 112, and 113 includes an AND gate having a signal of a plurality of bits (or a multi-bit signal) as an input/output. Also, the fault detection circuit 20A shows the case where each of all AND gates includes at least one logic gate in which polarities of an input and an output are inverted. However, this is provided as an example, and each of the sub logic gate circuits 111, 112, and 113 may include at least one logic gate which performs any other logic operation.

The fault detection circuit 20A may receive the input signal IS and may output the first final output signal OS1 and the second final output signal OS2. In this case, each of the input signal IS, the first final output signal OS1, and the second final output signal OS2 may be a multi-bit signal. The fault detection circuit 20A may compare the first final output signal OS1 and the second final output signal OS2 with the signal defined as the fault state FLTS to detect a fault.

In the case of FIG. 8, for example, because the true state TS is defined as a signal having data “01” and the false state FS is defined as a signal having data “10”, the remaining signals, that is, signals having data “11” and data “00” may be defined as the fault state FLTS.

Operations of the sub logic gate circuits 111, 112, and 113 will be described by using the sub logic gate circuit 111 as an example. As described with reference to FIG. 3B, the AND gate in which polarities of an input and an output are opposite to each other may be implemented by replacing the AND gate with the OR gate. Accordingly, the AND gate having a multi-bit signal as an input/output may be implemented by using an AND gate and an OR gate.

The sub logic gate circuit 111 may receive the input signal IS, may perform the logic operation on the input signal IS, and may output a result of the logic operation to the sub flip-flop circuit 121. The remaining sub logic gate circuits 112 and 113 may be electrically connected to a logic block 130. The logic block 130 of FIG. 8 is only a component defined for convenience of description and may include at least sub logic gate circuit 11N and/or at least one sub flip-flop circuit 12N.

Operations of the sub flip-flop circuits 121, 122, and 123 will be described by using the sub flip-flop circuit 123 as an example. As described with reference to FIG. 5, the sub flip-flop circuit 123 may include a plurality of flip-flops and a clock gating circuit.

The sub flip-flop circuit 123 may latch the FF input signal D[1:0] provided from the sub logic gate circuit 113 and may output the FF output signal Q[1:0] based on the clock signal CK. In this case, when the FF output signal Q[1:0] corresponds to the signal defined as the fault state FLTS, the sub flip-flop circuit 123 may adjust the clock signal CK to a data level of “0” through the clock gating circuit such that the FF output signal Q[1:0] is continuously fixed to the signal defined as the fault state FLTS.

Because the sub flip-flop circuit 123 is placed at the end of the logic circuit 100, the sub flip-flop circuit 123 may provide the FF output signal Q[1:0] to the compare circuit 200. In this case, the FF output signal Q[1:0] may correspond to the second final output signal OS2.

The compare circuit 200 may receive the first final output signal OS1 and the second final output signal OS2 from the logic circuit 100 and may output the error occurrence signal Err. In detail, the compare circuit 200 may compare each of the first final output signal OS1 and the second final output signal OS2 with the signal defined as the fault state FLTS and may detect whether the fault state FLTS is generated. For example, the compare circuit 200 may include XOR gates 210 and 211 and may compare the first final output signal OS1 and the second final output signal OS2 with the signal defined as the fault state FLTS.

In the case of FIG. 8, because the plurality of final output signals OS1 and OS2 are provided, the compare circuit 200 may further include an OR gate 220. For example, when at least one of comparison signals based on the comparison results of the plurality of XOR gates 210 and 211 is a signal having data “1”, the OR gate 220 may output a signal of data “1” corresponding to the error occurrence signal Err.

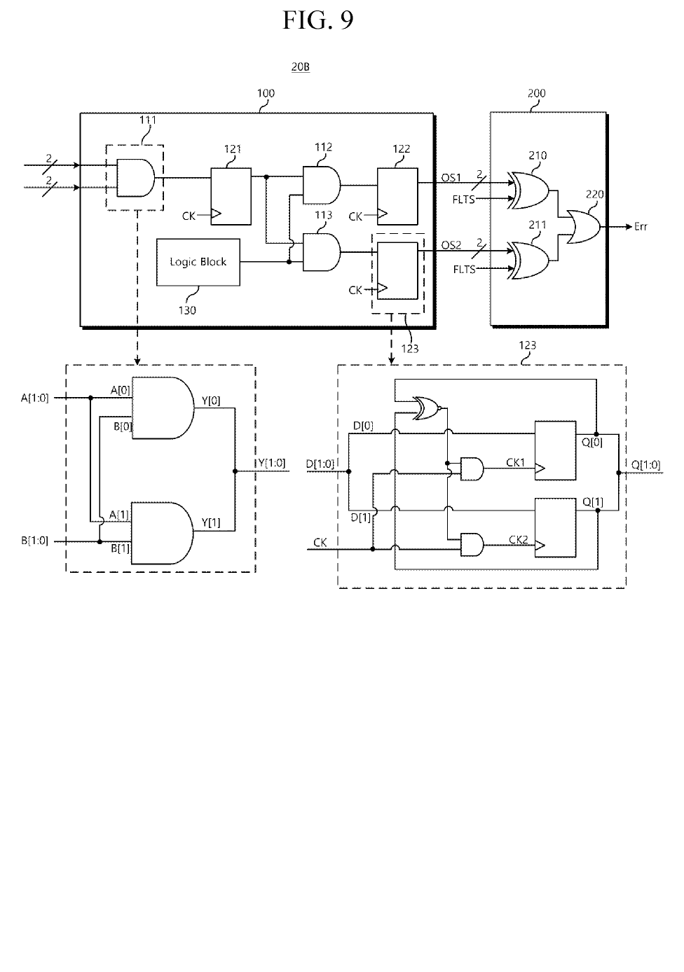

FIG. 9 is a diagram for describing an operation of a fault detection circuit 20B including only logic gates in which polarities of an input and an output are not inverted. The fault detection circuit 20B of FIG. 9 is similar to the fault detection circuits described with reference to FIGS. 1 to 8. Accordingly, below, the description which is the same as or similar to the description of the embodiments given with reference to FIGS. 1 to 8 will be omitted to avoid redundancy.

Referring to FIG. 9, for example, the fault detection circuit 20B shows the case in which each of the sub logic gate circuits 111, 112, and 113 includes an AND gate having a signal of a plurality of bits (or a multi-bit signal) as an input/output. Also, the fault detection circuit 20B shows the case where only AND gates in which polarities of an input and an output are not inverted. However, this is provided as an example, and each of the sub logic gate circuits 111, 112, and 113 may include at least one logic gate which performs any other logic operation.

The fault detection circuit 20B may receive the input signal IS and may output the first final output signal OS1 and the second final output signal OS2. In this case, each of the input signal IS, the first final output signal OS1, and the second final output signal OS2 may be a signal of a plurality of bits (or a multi-bit signal). The fault detection circuit 20B may compare the first final output signal OS1 and the second final output signal OS2 with the signal defined as the fault state FLTS to detect a fault.

In the case of FIG. 9, for example, because the true state TS is defined as a signal having data “11” and the false state FS is defined as a signal having data “00”, the remaining signals, that is, signals having data “01” and data “10” may be defined as the fault state FLTS.

Operations of the sub logic gate circuits 111, 112, and 113 will be described by using the sub logic gate circuit 111 as an example. An AND gate in which polarities of an input and an output are not inverted may be implemented by using a plurality of AND gates. The sub logic gate circuit 111 may receive the input signal IS, may perform the logic operation on the input signal IS, and may output a result of the logic operation to the sub flip-flop circuit 121.

The remaining sub logic gate circuits 112 and 113 may be electrically connected to the logic block 130. The logic block 130 of FIG. 9 is only a component defined for convenience of description and may include at least sub logic gate circuit 11N and/or at least one sub flip-flop circuit 12N.

Operations of the sub flip-flop circuits 121, 122, and 123 will be described by using the sub flip-flop circuit 123 as an example. As described with reference to FIG. 5, the sub flip-flop circuit 123 may include a plurality of flip-flops and a clock gating circuit.

The sub flip-flop circuit 123 may latch the input signal D[1:0] provided from the sub logic gate circuit 113 and may output the FF output signal Q[1:0] based on the clock signal CK. In this case, when the FF output signal Q[1:0] corresponds to the signal defined as the fault state FLTS, the sub flip-flop circuit 123 may adjust the clock signal CK to a data level of “0” through the clock gating circuit such that the FF output signal Q[1:0] is continuously fixed to the signal defined as the fault state FLTS.

Because the sub flip-flop circuit 123 is placed at the end of the logic circuit 100, the sub flip-flop circuit 123 may provide the FF output signal Q[1:0] to the compare circuit 200. In this case, the FF output signal Q[1:0] may correspond to the second final output signal OS2.

The compare circuit 200 may receive the first final output signal OS1 and the second final output signal OS2 from the logic circuit 100 and may output the error occurrence signal Err. In detail, the compare circuit 200 may compare each of the first final output signal OS1 and the second final output signal OS2 with the signal defined as the fault state FLTS and may detect whether the fault state FLTS is generated. For example, the compare circuit 200 may include the XOR gates 210 and 211 and may compare the first final output signal OS1 and the second final output signal OS2 with the signal defined as the fault state FLTS.

In the case of FIG. 9, because the plurality of final output signals OS1 and OS2 are provided, the compare circuit 200 may further include the OR gate 220. For example, when at least one of comparison signals based on the comparison results of the plurality of XOR gates 210 and 211 is a signal having data “1”, the OR gate 220 may output a signal of data “1” corresponding to the error occurrence signal Err.

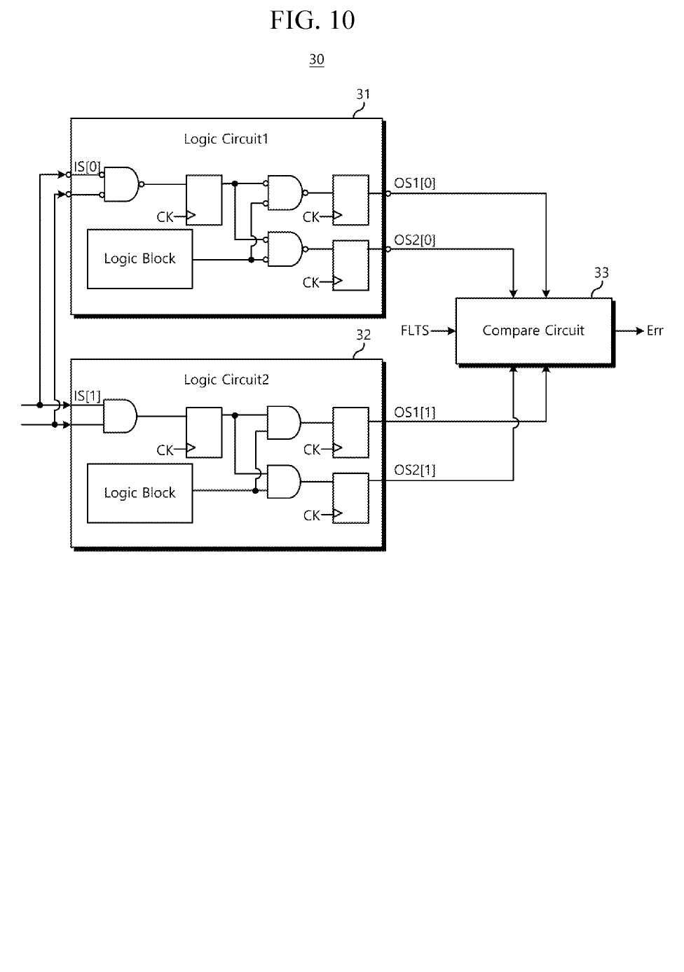

FIG. 10 is a diagram for describing an embodiment of a fault detection circuit 30 including a plurality of logic circuits. The fault detection circuit 30 of FIG. 10 is similar to the fault detection circuits described with reference to FIGS. 1 to 9. Accordingly, below, the description which is the same as or similar to the description of the embodiments given with reference to FIGS. 1 to 9 will be omitted to avoid redundancy.

As described above, the fault detection circuits described with reference to FIGS. 1 to 9 may be implemented by a logic gate circuit having a signal of a plurality of bits (or a multi-bit signal) as an input/output and a flip-flop circuit. However, this is provided as an example, and a fault detection circuit may be implemented by using a plurality of logic circuits. For example, the fault detection circuit 30 may be implemented by using a plurality of logic circuits 31 and 32 each having a single-bit signal as an input/output.

Referring to FIG. 10, the fault detection circuit 30 may include the first logic circuit 31, the second logic circuit 32, and a compare circuit 33.

The first logic circuit 31 may receive a first input signal IS[0] and may perform a logic operation. At least one final output signals OS1[0] and OS2[0] which the first logic circuit 31 outputs may be lower bit signals of the final output signals OS1[0] and OS2[0] which the compare circuit 33 intends to compare with the signal defined as the fault state FLTS.

The second logic circuit 32 may receive a second input signal IS[1] and may perform a logic operation. To detect whether a fault is generated in the first logic circuit 31, the second logic circuit 32 may operate in synchronization with the first logic circuit 31 in the lockstep method. At least one final output signals OS1[1] and OS2[1] which the second logic circuit 32 outputs may be upper bit signals of the final output signals OS1[0] and OS2[0] which the compare circuit 33 intends to compare with the signal defined as the fault state FLTS.

For example, when the final output signal OS1[0] corresponds to a signal having data “1” and the final output signal OS1[1] corresponds to a signal having data “1”, the first final output signal OS1 may correspond to a signal having data “11”. Because the signal having data “11” corresponds to the signal defined as the fault state FLTS, the compare circuit 33 may output the error occurrence signal Err based on a result of comparing the first final output signal OS1 and the signal defined as the fault state FLTS.

The flip-flop circuit which the fault detection circuit 30 includes may hold a signal which is output when a signal output from the clock gating circuit is the signal defined as the fault state FLTS. Accordingly, when the signal defined as the fault state FLTS is generated, the fault detection circuit 30 may continuously propagate the signal defined as the fault state FLTS to a next stage, and thus, the fault detection rate may be improved.

As a result, the fault detection circuit 30 may be an embodiment in which the logic circuit 100 of the fault detection circuit 10 of FIG. 1 is implemented by using the plurality of logic circuits 31 and 32.

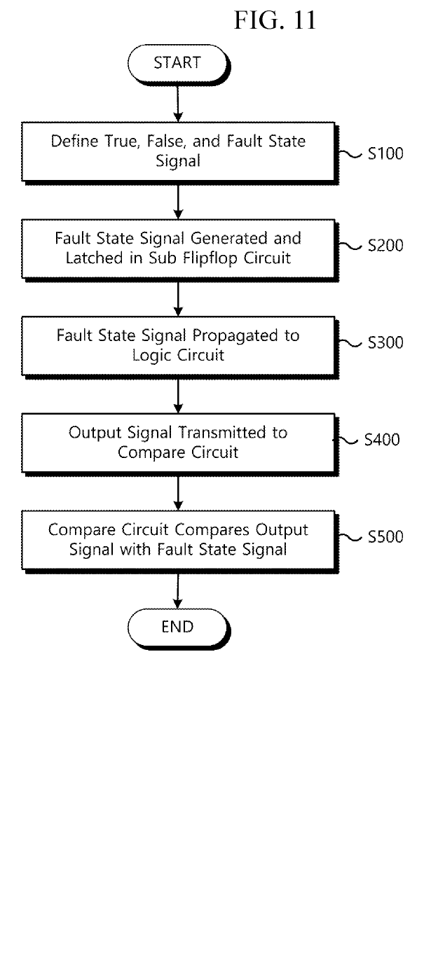

FIG. 11 is a flowchart describing an operation of the fault detection circuit 10. Components which are the same as or similar to those described above will be omitted to avoid redundancy.

In operation S100, the false state (FS) signal, the true state (TS) signal, and the signal defined as the fault state FLTS may be defined depending on a characteristic of the logic gate circuit 110. For example, when the logic gate circuit 110 includes a logic gate in which polarities of an input and an output are inverted, the true state (TS) signal may be defined as a signal having data “01”, the false state (FS) signal may be defined as a signal having data “10”, and the signal defined as the fault state FLTS may be defined as a signal having data “11” and a signal having data “00”.

In operation S200, the signal defined as the fault state FLTS which is generated in the sub logic gate circuit 11N by a fault due to the fault attack from the outside may be input to the sub logic gate circuit 12N so as to be latched.

In operation S300, the signal defined as the fault state FLTS may be continuously propagated to a next stage of the sub flip-flop circuit 12N in which the signal defined as the fault state FLTS is latched. For example, when the sub flip-flop circuit 12N outputs the signal defined as the fault state FLTS, the clock gating circuit may control the clock signal CK such that the output of the sub flip-flop circuit 12N is fixed to the signal defined as the fault state FLTS.

In operation S400, the final output signal OS of the logic circuit 100 may be provided to the compare circuit 200. For example, the FF output signal of the sub flip-flop circuit 12N located at the end of the logic circuit 100 may correspond to the final output signal OS of the logic circuit 100.

In operation S500, the compare circuit 200 may compare the final output signal OS provided from the logic circuit 100 with the signal defined as the fault state FLTS and may detect a fault. For example, the compare circuit 200 may include an XOR gate and may output a comparison signal based on a result of comparing the final output signal OS and the signal defined as the fault state FLTS. In this case, the comparison signal of the XOR gate may correspond to the error occurrence signal Err which the compare circuit 200 outputs.

As a result, as described above, when the fault state is generated, the fault detection circuit 10 may continuously propagate the signal defined as the fault state FLTS so as to be output as the final output signal OS. Accordingly, when the fault state is generated, the fault detection circuit 10 may continuously propagate the signal defined as the fault state FLTS so as to be transferred up to the output, and thus, a fault detection rate may be improved without increasing the burden of hardware compared to the related art.

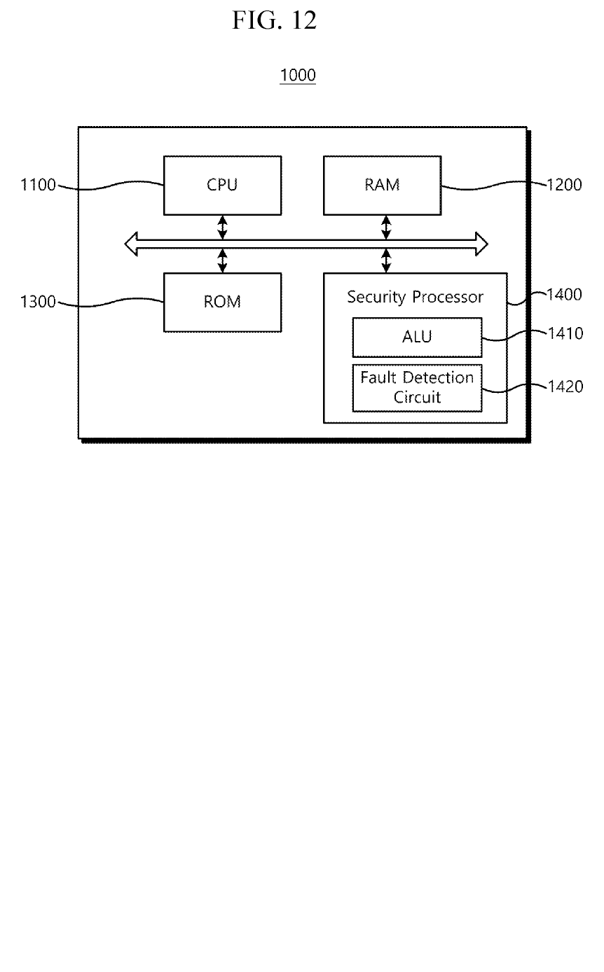

FIG. 12 is a diagram for describing an embodiment in which a fault detection circuit according to an embodiment of the present disclosure is applied to a security chip 1000.

Referring to FIG. 12, the security chip 1000 may include a CPU 1100, a RAM 1200, a ROM 1300, a security processor 1400, etc. The security chip 1000 may be a smart card or any one of various chips which store a security key.

The CPU 1100 may control all operations of the security chip 1000. For example, the CPU 1100 may drive an application or software loaded to the RAM 1200.

The RAM 1200 which is a volatile memory may store data to be processed by the security chip 1000, an operating system, firmware, an application, etc. For example, the RAM 1200 may include an SRAM.

The ROM 1300 which is a nonvolatile memory may store nonvolatile data such as an application program, an operating system of the CPU 1100, a constant parameter, etc. and may provide the stored data to the RAM 1200 when the security chip 1000 is booted up.

The security processor 1400 may perform an encryption, decryption, or signature operation on a message provided to the security chip 1000 by using an encryption function. The security processor 1400 may be isolated from an application processor of the smart card. Accordingly, the security may be improved by adding a separate security function in addition to a security function which the application processor provides.

The security processor 1400 may include an ALU 1410, a fault detection circuit 1420, etc.

The ALU 1410 may perform an arithmetic operation and a logic operation of the security processor 1400. For example, the ALU 1410 may receive an instruction, which the security processor 1400 receives and interprets, as input data. In the case, the ALU 1410 may perform an arithmetic operation such as four fundamental arithmetic operations and a logic operation on the received input data.

The fault detection circuit 1420 may detect a fault generated during the operation. For example, the fault detection circuit 1420 may detect an operation fault by verifying a result of the logic operation of the ALU 1410 of the security processor 1400.

In this case, when the fault state FLTS is generated, the fault detection circuit 1420 may continuously propagate the signal defined as the fault state FLTS so as to be transferred up to the output. In detail, the fault detection circuit 1420 may detect a fault through comparison with the signal defined as the fault state FLTS in advance.

The fault which the fault detection circuit 1420 detects may be an operation fault due to the fault attack from the outside, which is implemented by an optical glitch or a voltage glitch.

As described above, the fault detection circuit 1420 may detect the fault state FLTS generated by the fault attack from the outside implemented by an optical glitch or a voltage glitch within the security chip 1000. The fault detection circuit 1420 may detect the fault state FLTS so as to be used for the secure memory device such as a smart card including the security chip 1000 to take follow-up measures.

A fault detection circuit according to the present disclosure may improve the performance of detecting a fault attack through fault state propagation.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A fault detection circuit comprising:
a logic circuit; and
a compare circuit configured to detect whether a fault is generated in the logic circuit,
wherein the logic circuit includes:
a logic gate circuit including at least one sub logic gate circuit having a multi-bit signal including a plurality of bits as an input/output; and
a flip-flop circuit electrically connected to the logic gate circuit,
wherein the flip-flop circuit includes:
at least one sub flip-flop circuit configured to latch and output data of a signal which the at least one sub logic gate circuit outputs, and
wherein the compare circuit is configured to:
compare an output signal of the logic circuit and a fault state signal to generate a comparison result; and
detect whether the fault is generated in the logic circuit, based on the comparison result.

2. The fault detection circuit of claim 1, wherein the at least one sub logic gate circuit is electrically connected to at least another sub logic gate circuit or the flip-flop circuit.

3. The fault detection circuit of claim 2, wherein the at least one sub flip-flop circuit includes:
at least one D flip-flop configured to latch and output the data of the signal, which the at least one sub logic gate circuit outputs, based on a clock signal.

4. The fault detection circuit of claim 3, wherein, when the at least one D flip-flop outputs the fault state signal, the at least one sub flip-flop circuit holds data of an output signal of the at least one D flip-flop.

5. The fault detection circuit of claim 4, wherein the at least one sub flip-flop circuit further includes:
a clock gating circuit configured to adjust the clock signal to hold the data of the output signal of the at least one D flip-flop when the at least one D flip-flop outputs the fault state signal.

6. The fault detection circuit of claim 5, wherein the at least one sub logic gate circuit includes:
at least one logic gate in which polarities of an input and an output are inverted.

7. The fault detection circuit of claim 6, wherein the clock gating circuit includes:
at least one XOR gate or an AND gate.

8. The fault detection circuit of claim 5, wherein the at least one sub logic gate circuit includes:
only a logic gate in which polarities of an input and an output are identical.

9. The fault detection circuit of claim 8, wherein the clock gating circuit includes:
at least one XNOR gate or an AND gate.

10. The fault detection circuit of claim 1, wherein the compare circuit includes:
at least one XOR gate.

11. A fault detection circuit comprising:
a first logic circuit configured to receive a lower bit signal of a multi-bit input signal including a plurality of bits and to perform a logic operation on the lower bit signal;
a second logic circuit configured to receive an upper bit signal of the multi-bit input signal and to perform a logic operation on the upper bit signal, wherein the second logic circuit operates in synchronization with the first logic circuit in a lockstep method to detect whether a fault is generated in the first logic circuit; and
a compare circuit configured to output a comparison result obtained by comparing a multi-bit output signal of a plurality of bits, which includes output signals of the first logic circuit and the second logic circuit as a lower bit signal and an upper bit signal, with a fault state signal and to detect whether a fault is generated in the first logic circuit, based on the comparison result,
wherein the first logic circuit includes:
at least one logic gate circuit including a logic gate; and
at least one flip-flop circuit including a flip-flop electrically connected to the at least one logic gate circuit, and
wherein the flip-flop circuit includes:
at least one D flip-flop configured to latch and output an output received from the at least one logic gate circuit based on a clock signal; and
a clock gating circuit configured to hold data of an output signal of the at least one D flip-flop when the output signal of the at least one D flip-flop is the fault state signal.

12. A method of detecting a fault in a logic circuit, the method comprising:
defining a signal as a true state, a false state, or a fault state;
latching a fault state signal input to at least one sub flip-flop circuit included in the logic circuit when a fault is generated in at least one sub logic gate circuit included in the logic circuit;
propagating the fault state signal in the logic circuit;
outputting, at the logic circuit, an output signal; and
outputting, at a compare circuit, a comparison result obtained by comparing the fault state signal and the output signal and detecting whether a fault is generated based on the comparison result.

13. The method of claim 12, wherein the signal is a multi-bit signal including a plurality of bits,
wherein the at least one sub logic gate circuit includes:
at least one logic gate having a multi-bit signal including a plurality of bits as an input/output, and
wherein the at least one sub flip-flop circuit includes:
at least one flip-flop having a multi-bit signal including a plurality of bits as an input/output.

14. The method of claim 13, wherein the at least one sub flip-flop circuit includes:
at least one D flip-flop configured to latch and output data of a signal, which the at least one sub logic gate circuit outputs, based on a clock signal.

15. The method of claim 14, further comprising:
when the at least one D flip-flop outputs the fault state signal, holding data of the output signal of the at least one D flip-flop.

16. The method of claim 15, wherein the at least one sub flip-flop circuit further includes:
a clock gating circuit configured to adjust the clock signal to hold the data of the output signal of the at least one D flip-flop when the at least one D flip-flop outputs the fault state signal.

17. The method of claim 16, wherein the at least one sub logic gate circuit includes:
at least one logic gate in which polarities of an input and an output are inverted.

18. The method of claim 17, wherein the clock gating circuit includes:
at least one XOR gate or an AND gate.

19. The method of claim 16, wherein the at least one sub logic gate circuit includes:
only a logic gate in which polarities of an input and an output are identical.

20. The method of claim 19, wherein the clock gating circuit includes:
at least one XNOR gate or an AND gate.
